(19) United States
(12) Patent Application Publication
(10) Pub. No.: US 2005/0077110 A1
(43) Pub. Date: Apr. 14, 2005

(54) Shopping cart return system for parking lots

(76) Inventors: Betty Herman, Grand Junction, CO (US); Daniel Compton, Grand Juncton, CO (US)

Correspondence Address: LITMAN LAW OFFICES, LTD., P.O. BOX 15035 CRYSTAL CITY STATION, ARLINGTON, VA, 22215, US

(21) Appl. No.: 10/682,337

(22) Filed: Oct. 10, 2003

(51) Int. Cl. B61B 1/00; B61D 1/00; A47F 1/00; E04H 3/00; B65G 47/00

(52) U.S. Cl. 186/35

(57) ABSTRACT

A parking lot return system for shopping carts in a parking lot with a plurality of parking spaces. The parking lot return system for shopping carts has a plurality of central lanes with a front end, a back end, a left side and a right side with parking spaces provided on the left side and right side along the central lanes. There is also a plurality of shopping cart entrance lanes that feed into the central lanes from the left side and the right side of the central lanes as well as a plurality of curbing that forms the central lanes and separates the central lanes from the parking spaces and the parking lot.

### BACKGROUND OF THE INVENTION

1. Field of the Invention

The present invention relates to a system for organizing and gathering shopping carts on parking lots.

2. Description of the Related Art

Stray shopping carts can often cause problems in the parking lots of supermarket stores and discount stores that use many shopping carts. One of the problems with these stray shopping carts include persons driving into the shopping carts, which can cause damage to the shopping cart and the vehicle that runs into the shopping cart. Various systems are reflected in the related art that address this problem.

U.S. Pat. No. 3,772,994 issued to Juarbe on Nov. 20, 1973, outlines the use of a shopping cart control system for preventing the theft of shopping carts in which a track is mounted on the ground and extends from a store to the automobile parking area. The shopping cart is connected by a chain to a member slidably mounted in the track, but is not removable from the track, since the shopping cart can only travel along a defined path on the track.

U.S. Pat. No. 4,576,274 issued to Thorsen on Mar. 18, 1986, outlines the use of a system for the disposition of shopping carts including at least one storage area for the shopping carts, which are intended to be removed and returned from the storage area by users. Each storing area has at least one gate in an outlet passage to permit a shopping cart to pass therethrough only if a deposit is received. There is a gate in an inlet passage to permit the shopping carts to pass therethrough if identified as authorized, in which event the deposit is repaid.

U.S. Pat. No. 5,279,085 issued to DiPaolo et al. on Jan. 18, 1994, outlines the use of a covered walkway system for a parking lot of a store, such as a supermarket, having a covered walkway across the front of the store, covered branch walkways extending out from the cross walkway into the lot, with parking spaces marked off at opposite sides of the branch walkways and covered corrals for shopping carts extending out from the sides of the branch walkways.

U.S. Pat. No. 5,402,106 issued to DiPaolo et al. on Mar. 28, 1995, outlines the use of a shopping cart security system which assists in preventing the theft of a shopping cart from a parking lot of an establishment where shopping carts are used. The parking lot has at least one entrance and exit driveway. The system includes a magnet mounted on the shopping cart and an actuator buried below the surface of the driveway for generating a signal in response to passage of the cart with the magnet over the driveway.

U.S. Pat. No. 5,473,991 issued to Crum on Dec. 12, 1995, outlines the use of an apparatus for conveying work objects and more specifically, to such an apparatus which is particularly well suited to the return of shopping carts after their use.

U.S. Pat. No. 5,551,578 issued to McCue et al. on Sep. 3, 1996, outlines the use of a shopping cart station that has free-standing first and second hollow wall members filled with a ballast material. A connecting element couples the first and second hollow wall members together. The cart station can be easily moved and secured by emptying the hollow wall elements of the ballast material, repositioning the cart station and refilling the wall members with ballast.

U.S. Pat. No. 6,206,165 issued to Lenander on Mar. 27, 2001, outlines the use of a returning system for service carts, the system utilizing electronic monitoring of the movement of the service carts through an activity area.

German Pat. No. DE 3,112,655 granted to Wanzl on Oct. 14, 1982, outlines the use of an insertion opening equipped with two door wings, a conveying device, a shopping-trolley recognition device and a receipt-dispensing device. The conveying device has an electric cylinder with a piston, which can be screwed onto the floor. The stroke of the piston is limited by a stop, which is located at the front end of the piston and runs up against limit switches arranged a distance apart.

Although each of the outlined patents outline a novel and useful system for a parking lot return system for shopping carts, many of these systems are confusing and complicated. What is really needed is a simpler parking lot return system for shopping carts. Such a system would be well-received and would address a strong demand in the marketplace.

None of the above inventions and patents, taken either singly or in combination, is seen to describe the instant invention as claimed. Thus a parking lot return lane for shopping carts solving the aforementioned problems is desired.

### SUMMARY OF THE INVENTION

The invention is a parking lot return system for shopping carts in a parking lot with a plurality of parking spaces. The parking lot return system for shopping carts has central lanes with a front end, a back end, a left side and a right side with parking spaces provided on the left side and right side along the central lanes. There is also a plurality of shopping cart entrance lanes that feed into the central lanes from the left side and the right side of the central lanes as well as a plurality of curbing that forms the central lanes and separates the central lanes from the parking spaces and the parking lot.

Accordingly, it is a principal object of the invention to provide a simpler and more effective system for organizing stray shopping carts on parking lots.

It is another object of the invention to provide a way to collect stray shopping carts in a parking lot.

It is a further object of the invention to provide curbed pathways and stops for the flow and transport of shopping carts in a parking lot.

Still another object of the invention is to provide a system that will protect and separate shopping carts in a parking lot from vehicles in the parking lot.

It is an object of the invention to provide improved elements and arrangements thereof for the purposes described which are inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a parking lot return system for shopping carts according to the present invention.

FIG. 2 is an overhead perspective view of the parking lot return system for shopping carts.

Similar reference characters denote corresponding features consistently throughout the attached drawings.

### DETAILED DESCRIPTION OF THE PREFERRED EMBODIMENT

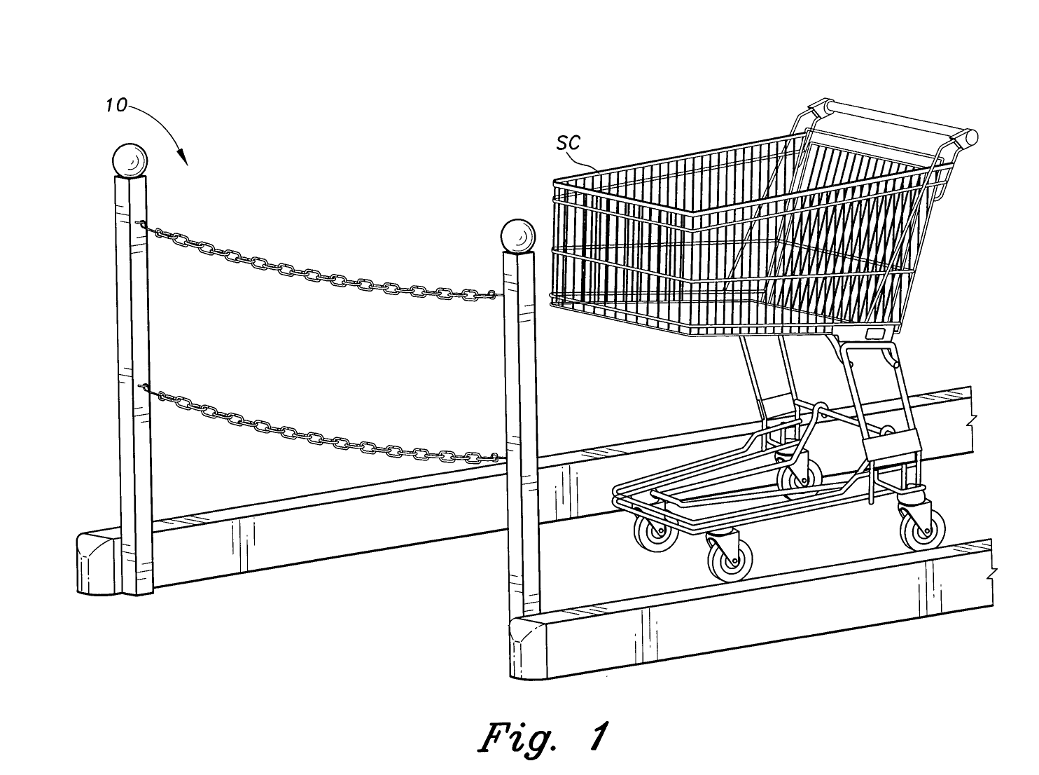

The present invention is a parking lot return system for shopping carts 10 in a parking lot with a plurality of parking spaces and shopping carts SC, as is shown in FIG. 1.

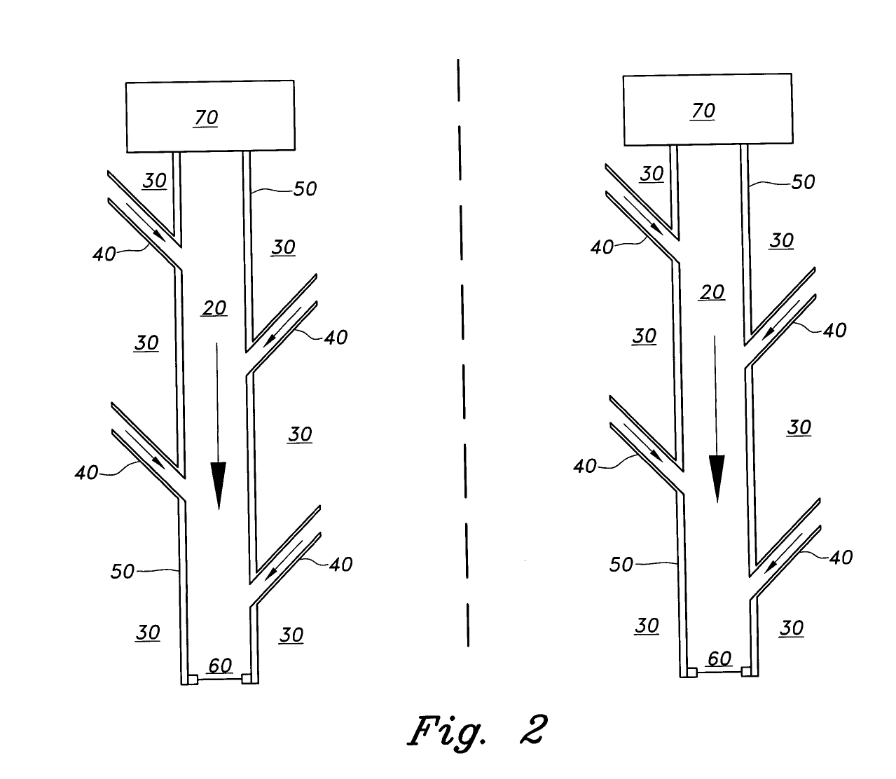

As depicted in FIG. 2, the parking lot return system for shopping carts 10 comprises a plurality of central lanes 20 with a front end, a back end, a left side and a right side with parking spaces 30 provided on the left side and the right side along the central lanes 20, a plurality of shopping cart entrance lanes 40 that feed into the central lanes 20 from the left side and the right side of the central lanes 20 and a plurality of curbing 50 that forms the central lanes 20 and separates the central lanes 20 from the parking spaces 30 and the parking lot. The parking lot return system for shopping carts 10 further comprises a stop area 60 located on the front end of the central lanes 20 and an island 70 that is provided on the back end of the central lanes 20 to close off the central lanes 20.

The central lanes 20 are typically disposed at the front of parking spaces 30 that are positioned on both the left and right sides of the central lanes 20. Although FIG. 2 depicts parking spaces 30 that are slanted or angled, the parking lot return system for shopping carts 10 can accommodate parking spaces 30 that are perpendicular to the central lanes 20 as well. The parking lot return system for shopping carts 10 can also accommodate handicapped parking spaces (not shown).

The central lanes 20 are approximately 4′ wide and can comfortably accommodate most shopping carts SC. The shopping carts SC are typically pushed into the central lanes 20 by hand through the plurality of shopping cart entrance lanes 40, which are placed on both sides of the central lanes 20. It is also typical that a user will push the shopping carts SC forward towards the stop area 60 on each central lane 20 as they are collected. The stop area 60 has a gate (not shown) that can be opened and closed manually. Typically the gate can be a plurality of removable chains that run across a pair of poles on each side of the stop area 60, or a hinged gate door that can swing open and latch shut when closed. Both types of gates are well-known to those schooled in the related art.

The parking lot return system for shopping carts 10 has a plurality of curbing 50 to define the boundaries of the central lanes 20. The plurality of curbing 50 is made of concrete and is 4″ high. The plurality of curbing 50 is durable enough to withstand contact from vehicles and shopping carts SC in the parking lot and can keep the shopping carts SC separate from any vehicles in the parking lot. The plurality of curbing 50 is also high enough to let a driver know when he or she has struck a section of the plurality of curbing 50.

There is also an island 70 provided on the back end of each of the central lanes 20. The island 70 is typically made of concrete or grass and serves to terminate the end of each of the central lanes 20. The island 70 is raised at curb level (4″) in comparison to the level of the central lanes 20 to provide further separation and definition.

Use of the parking lot return system for shopping carts 10 is straightforward. The parking lot return system for shopping carts 10 is intended for use by entities that use a lot of shopping carts SC as part of their business activity. This will include discount stores and grocery stores. As the central lanes 20 begins to fill with shopping carts SC, the accumulated shopping carts SC can be emptied from the central lanes 20 by opening the gate at the stop area 60 and clearing the accumulated shopping carts SC from the central lanes 20. The accumulated shopping carts SC are typically brought back into the discount store or grocery store for reuse.

There is no limit as to the number of the central lanes 20 that can be used in a parking lot return system for shopping carts 10. Typically the surface of the central lanes 20 is the same as that of the parking lot using the parking lot return system for shopping carts 10. This is usually asphalt paving, although concrete or other surfaces can be used as well.

It is to be understood that the present invention is not limited to the embodiments described above, but encompasses any and all embodiments within the scope of the following claims.

1. A parking lot return system for shopping carts in a parking lot with a plurality of parking spaces, comprising:
a plurality of central lanes with a front end, a back end, a left side and a right side with parking spaces provided on the left side and right side along the central lanes;
a plurality of shopping cart entrance lanes that feed into the central lanes from the left side and the right side of the central lanes;
a plurality of curbing that forms the central lanes and separates the central lanes from the parking spaces and the parking lot;
a stop area located on the front end of the central lanes; and
an island that is provided on the back end of the central lanes to close off the central lanes.

2. The parking lot return system according to claim 1, wherein the central lanes are 4′ wide.

3. The parking lot return system according to claim 1, wherein the curbing is made of concrete.

4. The parking lot return system according to claim 3, wherein the curbing is 41″ high.

5. The parking lot return system according to claim 1, wherein the stop area provides a gate that can be opened and closed.

6. The parking lot return system according to claim 5, wherein the gate is a plurality of removable chains that run across a pair of poles on each side of the stop area.

7. The parking lot return system according to claim 5, wherein the gate is a hinged gate door that can swing open and latch shut when closed.
